(19) United States
(12) Patent Application Publication
(10) Pub. No.: US 2013/0144805 A1
(43) Pub. Date: Jun. 6, 2013

(54) GEOSPATIAL DATA BASED MEASUREMENT OF RISK ASSOCIATED WITH A VEHICULAR SECURITY INTEREST IN A VEHICULAR LOAN PORTFOLIO

(71) Applicants: Brian Boling, Knoxville, TN (US); Curtis Schantz, Scottsdale, AZ (US); Tom Beerle, Burlingame, CA (US)

(72) Inventors: Brian Boling, Knoxville, TN (US); Curtis Schantz, Scottsdale, AZ (US); Tom Beerle, Burlingame, CA (US)

(73) Assignee: PROCONGPS, INC., Knoxville, TN (US)

(21) Appl. No.: 13/328,070

(22) Filed: Dec. 16, 2011

Related U.S. Application Data
(63) Continuation-in-part of application No. 13/310,629, filed on Dec. 2, 2011.

(51) Int. Cl. G06Q 40/06

(52) U.S. Cl. 705/36 R

(57) ABSTRACT

A method of geospatial data based assessment of a vehicular security interest in a vehicular loan portfolio is disclosed. The method may involve permitting a party having a vehicular security interest and/or a party interested in acquiring the vehicular security interest and/or a vehicular loan portfolio access to dynamically determined vehicle location and pattern of usage information associable with the vehicle through a geospatial positioning device within the vehicle. A risk scoring methodology may be developed that may contribute to the assessment of the financial value of the vehicular security interest and/or the vehicular loan portfolio when there is a match between an event and the location and pattern of usage information associable with the vehicle. Subsequently, a risk score associated with the vehicular security interest and/or the vehicular loan portfolio based on the risk scoring methodology may be generated.

### CLAIM OF PRIORITY

This application is a Continuation-In-Part (CIP) of and incorporates by references in its entirety, U.S. Utility patent application Ser. No. 13/310,629 titled “ALERT GENERATION BASED ON A GEOGRAPHIC TRANSGRESSION OF A VEHICLE” and filed on Dec. 2, 2011.

### FIELD OF TECHNOLOGY

This disclosure relates generally to using geospatial data to assess financial risk associated with a security interest, and in one example embodiment, using geospatial data to determine a borrower's historical location and pattern of use behavior and to generate a risk score associated with a vehicular security interest and/or a vehicular loan portfolio. The risk score may be utilized by a party interested in assessing the financial value prior to acquiring the vehicular security interest and/or the vehicular loan portfolio.

### BACKGROUND

Parties interested in acquiring a security interest in a vehicle or a loan portfolio comprising several vehicles (i.e., a vehicular loan portfolio) may be interested in assessing the financial value of the security interest or the loan portfolio prior to executing a transaction with a seller. The financial value and the financial risk associated with the vehicular security interest or the vehicular loan portfolio may be assessed using geospatial data retrieved from the vehicle. This geospatial data may give interested parties and/or buyers an understanding of the borrower's driving patterns and thus may contribute to the assessment of the financial value of the security interest (i.e., a single vehicle or a portfolio of multiple vehicles).

Interested parties may use and/or employ geospatial positioning devices that communicate geospatial data based on a worldwide navigational and surveying facility dependent on the reception of signals from an array of orbiting satellites (e.g., Global Positioning System (GPS) technology). Another device might be a Real Time Locator System (RTLS) which uses Radio Frequency Identification (RFID) technology to transmit the physical location of RFID tagged objects. In addition, such geospatial positioning devices may be placed directly within vehicles by Original Equipment Manufacturers (OEMs). For example, car manufacturers may install OEM telematics solutions (e.g., OnStar™) within all their vehicles.

The use of GPS, RTLS, RFID or OEM telematics based geospatial positioning devices to enable the gathering of geospatial data is gaining prominence. In the subprime vehicle finance market, such geospatial positioning devices are frequently used to track a borrower's vehicle and to alert a party of interest of the location of the vehicle. More importantly, certain locations, driving behaviors or patterns of movement associated with the borrower and his/her vehicle may be indicative of an increased or decreased financial risk and a corresponding financial value associated with the vehicular security interest.

Generally, vehicles, such as automobiles, are financed through captive OEM lenders and third party lending institutions such as a bank, a credit union, a specialty finance company or an automobile dealer. The borrower or purchaser of the vehicle borrows money from the lending institution and makes monthly payments on the loan to the lending institution. Typically, title to the vehicle remains with the lending institution until the loan amount has been paid in full. However, the lending institution may want to sell the security interest in the vehicle to another party or may want to bundle several vehicles into a vehicular loan portfolio, and sell that loan portfolio.

As such, assessing the financial value of the security interest or the loan portfolio in addition to measuring financial risk is of paramount importance to the buyer. In addition, obtaining information on events, historical locations, and pattern of use behaviors that could be reliable indicators of the financial value of the security interest may therefore be valuable for the lending institution or the buyer. Further, dynamically determining an event affecting the asset (i.e., the vehicle) or a landmark to be monitored may therefore also be very valuable to the lending institution or the buyer of the vehicular security interest and/or vehicular loan portfolio.

For example, one reliable indicator of the financial value of a vehicular security interest may be the physical location of the vehicle. If the vehicle is in an impound yard, it is likely that the vehicle may have been rendered immobile or may have some other problem thus increasing the financial risk and lowering the financial value associated with that particular vehicular security interest. This determination may be extrapolated to analyze and assess an entire portfolio of vehicles. Therefore, what is needed is a method for utilizing geospatial data (e.g., locational data associated with the borrower's vehicle) to assess the financial value of and the financial risk associated with a vehicular security interest and/or a vehicular loan portfolio.

### SUMMARY

A method of geospatial data based assessment of a vehicular security interest in a vehicular loan portfolio is disclosed. In one aspect, the method may involve permitting a party (e.g., a lending institution) having a vehicular security interest and/or a party interested in acquiring the vehicular security interest and/or a vehicular loan portfolio that may comprise multiple singular vehicular security interests (e.g., a loan portfolio buyer), access to dynamically determined vehicle location and pattern of usage information associable with the vehicle through a geospatial positioning device installed within the vehicle.

In another aspect a data link may utilize a base terminal communicatively coupled to the geospatial positioning device such that geospatial data associated with the vehicle may be transmitted from the geospatial positioning device to the base terminal via the data link. The geospatial data received from the geospatial positioning device via the data link may be used to determine the location of the vehicle and/or the pattern of usage information associable with the vehicle. According to this aspect, the location of the vehicle and the pattern of usage information associable with the vehicle and received from the geospatial positioning device may then be compared to an event (e.g., comprised by one or more exemplary financial value data points).

The location of the vehicle and the pattern of usage information gleaned from the GPS geospatial positioning device in the vehicle may consist of one or more events that may affect the financial value and risk score of the vehicular security interest and/or vehicular loan portfolio. In one exemplary aspect, a risk scoring methodology may be developed that may contribute to the assessment of the financial value of the vehicular security interest and/or the vehicular loan portfolio when there is a match between the event and the location and pattern of usage information associable with the vehicle. Subsequently, a risk score associated with the vehicular security interest and/or the vehicular loan portfolio based on the risk scoring methodology may be generated.

In at least one illustrative aspect, the method may comprise receiving geospatial data from a vehicle equipped with a geospatial positioning device capable of transmitting geospatial data (associated with the vehicle) to a base terminal. The geospatial data associated with the vehicle may then be stored in a dynamic table format associable with a vehicular loan portfolio to permit or facilitate the searching of and/or access to one or more geospatial data point extrapolated from geospatial data associated with the vehicle. The vehicular loan portfolio may then be populated with geospatial data received from multiple vehicles associated with multiple geospatial data points.

It will be appreciated that, according to one aspect, geospatial data points associated with multiple vehicles and multiple financial risk factors attributable to the vehicular loan portfolio may be compared. It may then be determined that the geospatial data points associated with multiple vehicles may be indicative of an increased or decreased financial risk associated with the entire vehicular loan portfolio. A risk scoring methodology based on multiple financial risk factors attributable to the vehicular loan portfolio at large may thus be developed. In addition, a risk score indicative of the financial risk attributable to the vehicular loan portfolio may be generated. This risk score may ultimately have a positive or negative effect on the financial value of a singular vehicular security interest or an entire vehicular loan portfolio.

The methods and systems disclosed herein may be implemented by any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1A illustrates a location view showing access of the location and pattern of usage information of the vehicle having the security interest, according to one or more embodiments.

FIG. 1B is a flow chart illustrating the ultimate generation of a risk score from the initial gathering of geospatial data, according to one or more embodiments.

FIG. 2 illustrates a module view wherein the methods and systems disclosed herein may be implemented by any means for achieving various aspects, according to one or more embodiments.

FIGS. 3A and 3B illustrate determining the location and pattern of usage information from geospatial data transmitted from the vehicle and comparing the location and pattern of usage information to one or more events, according to one or more embodiments.

FIG. 4A is a table view illustrating the effect of events (associated with location and pattern of usage information) on the financial value and financial risk associated with the security interest, according to one or more embodiments.

FIG. 4B illustrates other risk scoring methodologies and exemplary financial value data points that may be used to assess the financial value of the security interest, according to one or more embodiments.

FIG. 5 is a dynamic landmark view illustrating dynamically determining an event affecting the security interest or a landmark to be monitored, according to one or more embodiments.

FIG. 6 is a vehicular loan portfolio view illustrating a pie chart that details just one possible aspect of the vehicular loan portfolio with multiple vehicles and multiple risk scores, according to one or more embodiments.

FIG. 7 is a flow chart illustrating the extrapolation of geospatial data to a dynamic table format to assess financial value and/or financial risk of the vehicular loan portfolio, according to one or more embodiments.

FIG. 8 is a dynamic table view that illustrates the determination of financial value and financial risk associated with the vehicular loan portfolio, according to one or more embodiments.

FIG. 9 is a diagrammatic view of a data processing system in which any of the embodiments disclosed herein may be performed, according to one embodiment.

Other features of the present embodiments will be apparent from the accompanying drawings and from the detailed description that follows.

### DETAILED DISCLOSURE

A method comprising permitting a party having a vehicular security interest 110 and a party interested in acquiring the vehicular security interest and/or a vehicular loan portfolio 112, access to the location of a vehicle 106 and the pattern of usage information 108 associable with a vehicle 102 through a geospatial positioning device 104 installed within the vehicle 102 is disclosed. According to one or more embodiments, a data link from a base terminal communicatively coupled to the geospatial positioning device 104 may be utilized such that geospatial data 302 associated with the vehicle 102 may be transmitted from the geospatial positioning device 104 to the base terminal via the data link. The location of the vehicle 106 and the pattern of usage information 108 associable with the vehicle 102 may be determined based on geospatial data 302 received from the geospatial positioning device 104 via the data link.

In one exemplary embodiment, the location of the vehicle 106 and the pattern of usage information 108 associable with the vehicle 102 and received from the geospatial positioning device 104 may be compared to an event 402. A risk scoring methodology 406 that contributes to the assessment of the financial value 404 of the vehicular security interest 114 and/or vehicular loan portfolio 602 may be developed if the location of the vehicle 106 and the pattern of usage information 108 associable with the vehicle 102 matches the event 402. In addition, a risk score 604 associated with the vehicular security interest 114 and the vehicular loan portfolio 602 may be generated based on the risk scoring methodology 406, according to one or more embodiments.

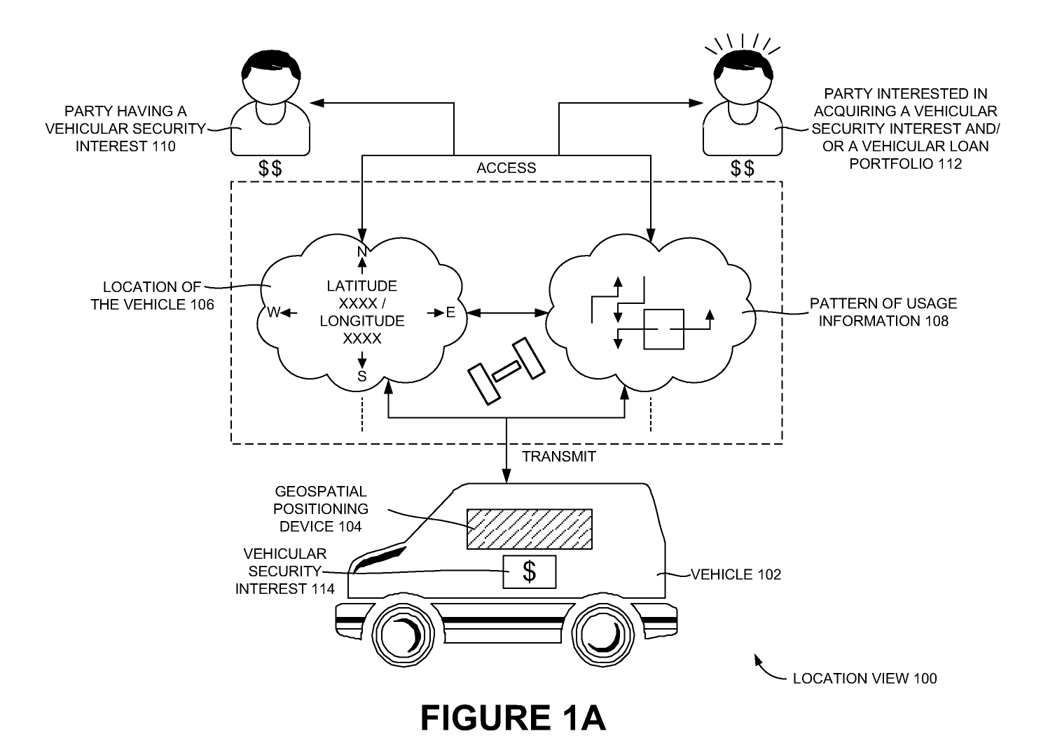

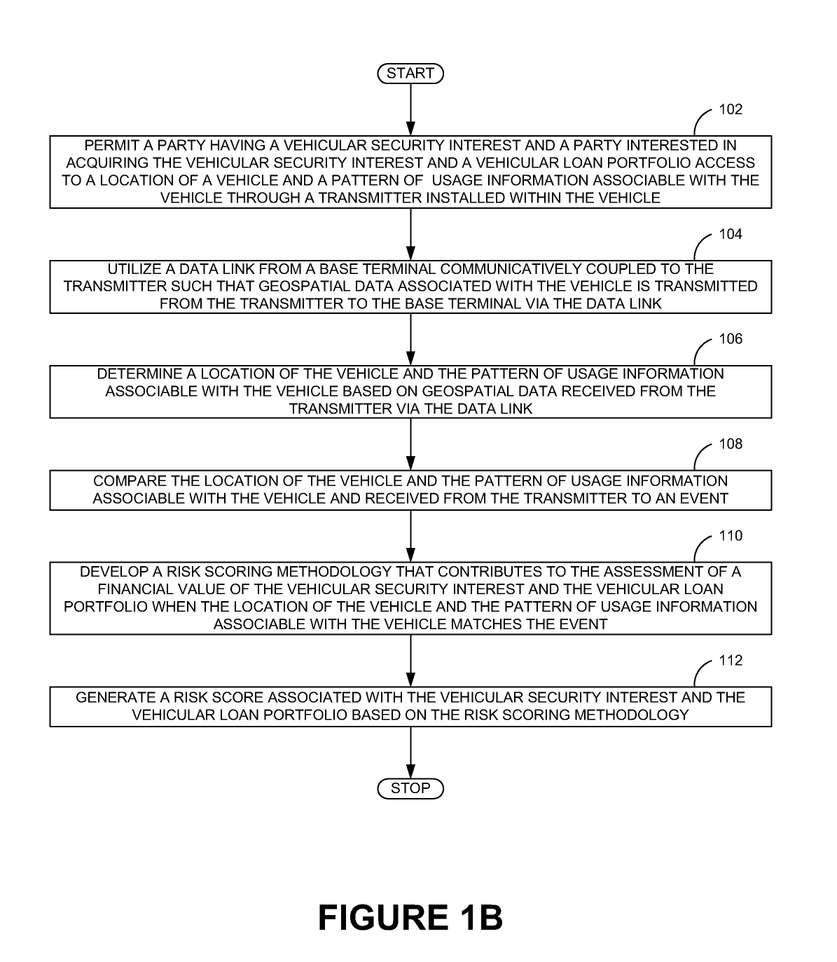

FIG. 1A illustrates a location view 100 showing access of the location of the vehicle 106 and pattern of usage information 108 of the vehicular security interest 114, according to one or more embodiments. The party having the vehicular security interest 110 and/or the party interested in acquiring the vehicular security interest and/or vehicular loan portfolio 112 may have access or may be provided access to the location of the vehicle 106 and the pattern of usage information 108 gleaned from and transmitted by the geospatial positioning device 104 installed in the vehicle 102 (i.e., vehicular security interest 114). According to one or more embodiments, geospatial positioning device 104 may be based on GPS, RTLS, RFID or OEM telematics. In addition, the vehicular security interest 114 may be a property interest created by agreement (e.g., a loan agreement between a lender and a borrower) or by operation of law over assets (e.g., a vehicle 102) to secure the performance of an obligation, usually the payment of a debt (e.g., a loan obligation). It may give the beneficiary (e.g., the party having the vehicular security interest 110 and/or the party interested in acquiring the vehicular security interest and/or vehicular loan portfolio 112) of the vehicular security interest 114 certain preferential rights in the disposition of secured assets (e.g., the vehicle 102). For example, the holder of the vehicular security interest 114 may be entitled to seize and sell vehicle 102 to discharge the debt that vehicular security interest 114 may secure, according to one or more exemplary embodiments.

FIG. 1B is a flow chart illustrating the generation of a risk score 604 from the initial gathering of geospatial data 302, according to one or more embodiments. The party having the vehicular security interest 110 and/or the party interested in acquiring the vehicular security interest and/or a vehicular loan portfolio 112 (e.g., a bank) may have access to the location of the vehicle 106 and the pattern of usage information 108 associable with the vehicle 102 (e.g., through a GPS, RTLS, RFID or OEM telematics based geospatial positioning device). According to one or more embodiments, the location of the vehicle 106 and the pattern of usage information 108 associable with the vehicle 102 and received from the geospatial positioning device 104 may be compared to an event 402, and a risk scoring methodology 406 that contributes to the assessment of the financial value 404 of the vehicular security interest 114 and/or vehicular loan portfolio 602 may be developed if the location of the vehicle 106 and the pattern of usage information 108 associable with the vehicle 102 matches the event 402. According to one embodiment, a risk score 604 associated with the vehicular security interest 114 and the vehicular loan portfolio 602 may be generated based on the risk scoring methodology 406.

It will be appreciated that the party having the vehicular security interest 110 and/or the party interested in acquiring the vehicular security interest and/or vehicular loan portfolio 112 may be an organization. The organization may possess the vehicular security interest 114 in vehicle 102. The organization may be a corporation, a partnership, an individual, a government, a non-governmental organization, an international organization, an armed force, a charity, a not-for-profit corporation, a cooperative, or a university. It may be a hybrid organization that may operate in both the public sector and the private sector, simultaneously fulfilling public duties and developing commercial market activities, according to one or more embodiments. The party having the vehicular security interest 110 and/or the party interested in acquiring the vehicular security interest and/or vehicular loan portfolio 112 may be an agent of an organization (e.g., a bank, a lender, or any other lending institution or person) that may possess the vehicular security interest 114 in vehicle 102. The relationship between the organization and the party having the vehicular security interest 110 and/or the party interested in acquiring the vehicular security interest and/or vehicular loan portfolio 112 may expressly or impliedly authorize the party having the vehicular security interest 110 and/or the party interested in acquiring the vehicular security interest and/or vehicular loan portfolio 112 to work under the control and on behalf of the organization. The party having the vehicular security interest 110 and/or the party interested in acquiring the vehicular security interest and/or vehicular loan portfolio 112 may thus be required to negotiate on behalf of the organization to secure and/or provide services. The vehicular security interest 114 may be a singular security interest associated with one vehicle or a vehicular loan portfolio security interest associated with multiple vehicles, according to one or more embodiments.

In one or more embodiments, the location of the vehicle 106 may be automatically determined based on a situs of a purchaser, a lessee, or a renter of the vehicle 102. The situs may be determined using GPS technology and may be the location where the borrower's (e.g., a purchaser, a lessee, or a renter of vehicle 102) property may be treated as being located for legal and jurisdictional purposes, according to one embodiment. The situs may also be the place where property is situated (e.g., the impound lot). It may also be the permanent location of certain property (e.g., the borrower's location of work or the borrower's home). The situs may be a home address or a work address of the borrower (e.g., a purchaser, a lessee, or a renter of vehicle 102). The borrower may have multiple locations, according to one embodiment.

According to an illustrative example, pattern of usage information 108 may be associated with vehicle 102 based on the periodic analysis of the location of the vehicle 106. This pattern of usage information 108 may include a particular predetermined movement of vehicle 102. For example, and according to one or more embodiments, vehicle 102 may not have moved from its current location for a period of time, the borrower of vehicle 102 may have left the state and/or country, vehicle 102 may not have been driven for a certain period of time, or vehicle 102 may have been driven, but too infrequently (e.g., less than 10 miles). The number of ignition starts and stops (e.g., the borrower may not have started vehicle 102 for a period of time or may have only started vehicle 102 once in a given week) and vehicle 102 moving without the vehicle 102 being turned on (e.g., a sign that vehicle 102 may be getting towed) may also be communicated as pattern of usage information 108. The amount of time may vary as determined by either the party having the vehicular security interest 110 and/or the party interested in acquiring the vehicular security interest and/or vehicular loan portfolio 112, a lender (e.g., a bank or lending institution) or a provider (e.g., a company selling GPS geospatial positioning devices and/or a company providing the corresponding web interface to track vehicles). The party having the vehicular security interest 110 and/or the party interested in acquiring the vehicular security interest and/or vehicular loan portfolio 112 may sell the hardware (e.g., geospatial positioning device 104) and/or may provide a software solution to track vehicle 102. The predetermined distance may be determined by the party having a vehicular security interest 110 and/or the party interested in acquiring the vehicular security interest and/or the vehicular loan portfolio 112, according to one or more embodiments.

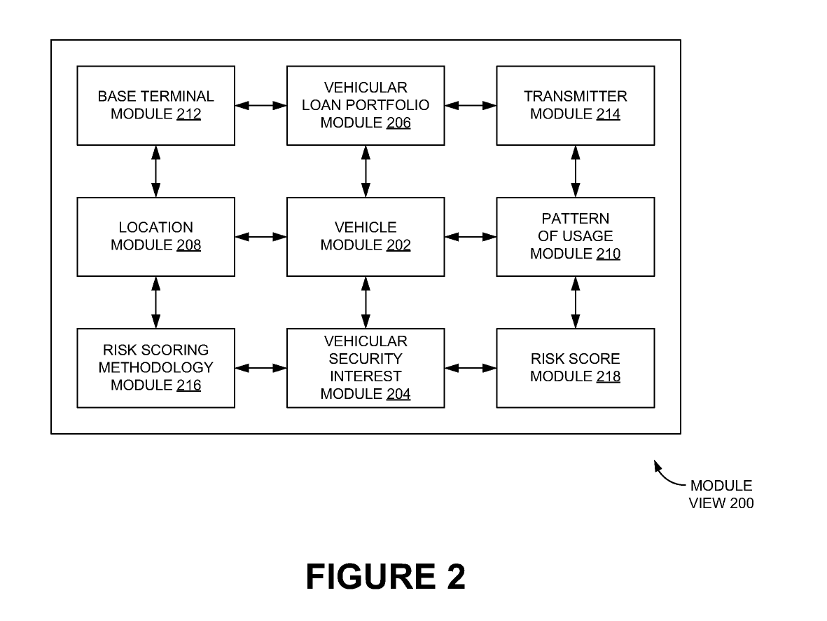

FIG. 2 illustrates a module view 200 wherein the methods and systems disclosed herein may be implemented by any means for achieving various aspects, according to one or more embodiments. The vehicle module 202 may perform all tasks associated with vehicle 102. The vehicular security interest module 204 may assess the financial value 404 of the vehicular security interest 114. The vehicular loan portfolio module 206 may determine the risk score 604 attributable to the vehicular loan portfolio 602. The location module 208 may determine the location of the vehicle 106 and the pattern of usage module 210 may determine the pattern of usage information 108, associable with vehicle 102 and thereby the vehicular security interest 114. The base terminal module 212 may permit a base terminal to be communicatively coupled to the geospatial positioning device 104 such that geospatial data 302 associated with vehicle 102 may be transmitted from the geospatial positioning device 104 to the base terminal via a data link, according to one embodiment. The geospatial positioning device module 214 may transmit geospatial data 302, the location of the vehicle 106 and/or pattern of usage information 108 associated with vehicle 102 to the base terminal to permit comparison with an event 402. The risk methodology module 216 may permit the development of the risk scoring methodology 406 that may contribute to the assessment of financial value 404 of the vehicular security interest 114 and/or the vehicular loan portfolio 602 when the location of vehicle 106 and the pattern of usage information 108 associable with vehicle 102 matches event 402, according to one or more embodiments. Finally, the risk score module 218 may generate a risk score 604 associated with the vehicular security interest 114 and/or the vehicular loan portfolio 602 based on the risk scoring methodology 406, according to one embodiment. The location of the vehicle 106 and the pattern of usage information 108 associable with the vehicle 102 may be utilized to create the risk score 604 indicative of the financial value 404 of the vehicular security interest 114, according to other embodiments.

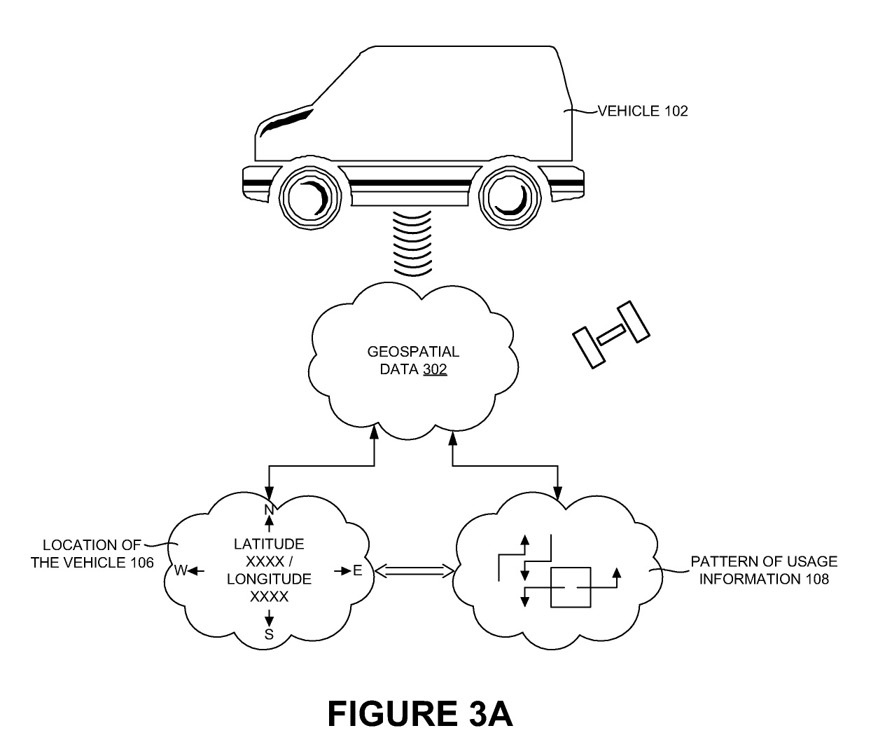

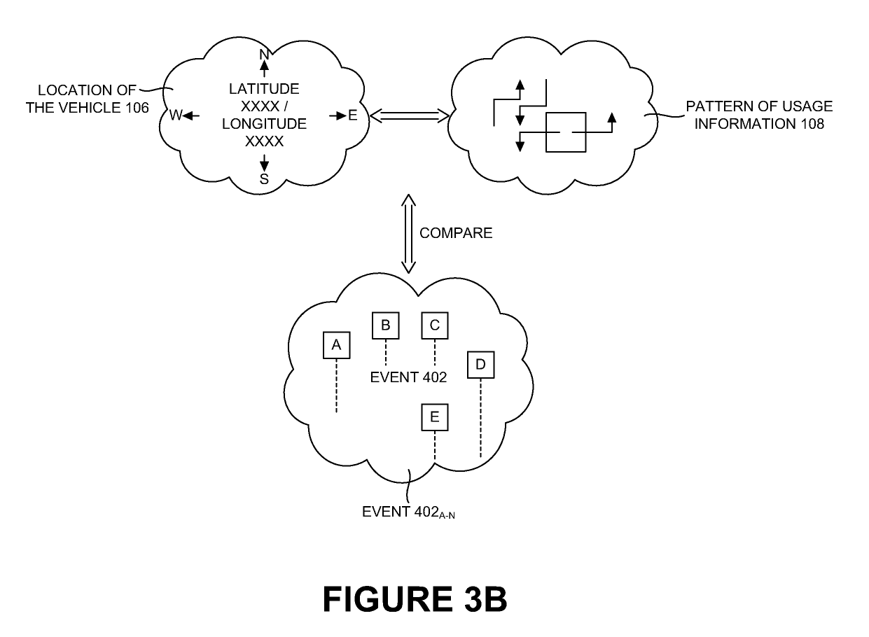

FIGS. 3A and 3B illustrate determining the location of the vehicle 106 and pattern of usage information 108 from geospatial data 302 transmitted from vehicle 102 and comparing the location of the vehicle 106 and pattern of usage information 108 to one or more events, according to one or more embodiments. According to one embodiment, an algorithm may be applied to determine the location of the vehicle 106 associated with the vehicle 102 based on the pattern of usage information 108. For example, the vehicle 102 may have not arrived at the borrower's home for the past two weeks. The amount of time and the distance traveled may vary and may be determined by the party having the vehicular security interest 110 and/or the party interested in acquiring the vehicular security interest and/or vehicular loan portfolio 112. Further, and according to one embodiment, the risk scoring methodology 406 may be automatically changed based on an application of an algorithm. For example, if vehicle 102 has left the state, the algorithm may pick a risk scoring methodology 406 that may indicate a higher risk score 604 and a lower financial value 404. The changes and adjustments may be based on predetermined locations, predetermined distances, or predetermined times and may be decided by the party having the vehicular security interest 110 and/or the party interested in acquiring the vehicular security interest and/or vehicular loan portfolio 112, according to one or more exemplary embodiments.

According to one or more illustrative examples, the event 402 may be any event based on the location of the vehicle 106 and the pattern of usage information 108. Multiple events may be algorithmically determined. The event 402 may be a predetermined combination of events including locations and times associated with the borrower and vehicle 102. Event 402 may be predetermined by the party having the vehicular security interest 110 and/or the party interested in acquiring the vehicular security interest and/or vehicular loan portfolio 112. According to one embodiment, event 402 may be a location based predictive indicator of the financial value 404 of the vehicular security interest 114 and/or the vehicular loan portfolio 602. Event 402 may be determined by the party having the vehicular security interest 110 and/or the party interested in acquiring the vehicular security interest and/or the vehicular loan portfolio 112. It may be associated the location of the vehicle 106 and the pattern of usage information 108 associable with vehicle 102. Event 402 may comprise vehicle 102 not having moved from its current location for a period of time, vehicle 102 not having traveled a predetermined distance for a period of time, an ignition of vehicle 102 having not been started and stopped a predetermined number of times, vehicle 102 having been at a predetermined location, and vehicle 102 not having been at a predetermined location, according to one or more embodiments.

Vehicle 102, according to one or more embodiments, may be an asset (e.g., the vehicle may be used as collateral by a lender in a loan transaction) and may refer to all forms of transportation including cars, motorcycles, planes, trucks, heavy equipment, jet skis, and all other modes of commercial and/or recreational transportation. The party having the vehicular security interest 110 and/or the party interested in acquiring the vehicular security interest and/or vehicular loan portfolio 112 may be a company that provides GPS devices, GPS vehicle tracking services, OEM telematics (e.g., OnStar™), payment reminder services, vehicle repossession services, or payment assurance services. The party having the vehicular security interest 110 and/or the party interested in acquiring the vehicular security interest and/or vehicular loan portfolio 112 may also provide fleet tracking and mobile asset management services. It may also be a sub-prime vehicle finance and/or asset tracking company, a financial institution, an automobile dealership, a specialty finance company, a dealership finance company, a bank, a credit union, or a private financier in addition to any entity or organization, according to one or more exemplary embodiments.

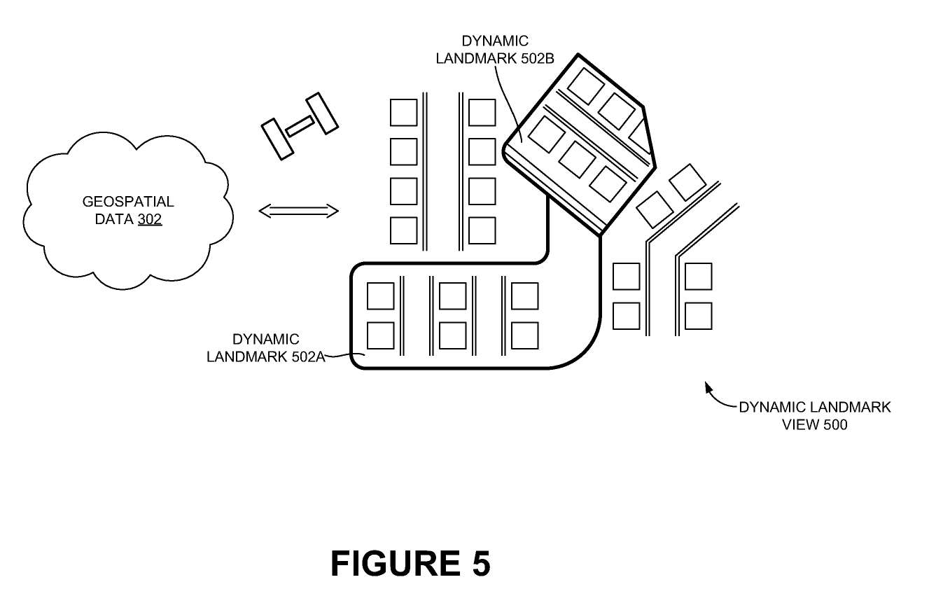

FIG. 5 a dynamic landmark view 500 illustrating dynamically determining event 402 affecting the vehicular security interest 114 or a dynamic landmark 502 to be monitored, according to one or more embodiments. The location of the vehicle 106 and the pattern of usage information 108 associable with the vehicle that may be incorporated in the vehicular loan portfolio 602 and that may currently have the vehicular security interest 114 may be based on dynamic landmark 502 associated with vehicle 102. Similarly, geospatial data 302 received from the geospatial positioning device 104 may be associated with dynamic landmark 502 and may be utilized to compute the time vehicle 102 that may be incorporated in the vehicular loan portfolio 602 spends at dynamic landmark 502. According to one or more embodiments, dynamic landmarks (e.g., dynamic landmark 502A or dynamic landmark 502B) may be generated using an ignition event associated with vehicle 102 incorporated in vehicular loan portfolio 602. They may also be generated using known information (e.g., location of the vehicle 106) provided by an owner of the vehicular security interest 114, a historical location, and from pattern of use behavior (e.g., pattern of usage information 108). Dynamic landmark 502 may be used to create a pattern of usage profile associated with vehicle 102 incorporated in the vehicular loan portfolio 602. In addition, the predetermined location may also be dynamically generated using geospatial data 302 and/or the pattern of usage information 108 by the party having the vehicular security interest 110 and/or the party interested in acquiring the vehicular security interest and/or the vehicular loan portfolio 112, according to one or more illustrative embodiments.

According to one or more embodiments, the ignition event associated with vehicle 102 may be used to generate and inventory dynamic landmark 502 related to and associated with vehicle 102 and with event 402. Multiple ignition events associated with vehicle 102 may be used to generate and inventory multiple dynamic landmarks related to and associated with vehicle 102 and event 402. The location of the vehicle 106 and pattern of usage information 108 may be generated automatically using one or more ignition events to generate and inventory dynamic landmark 502 associated with vehicle 102. For example, the party having the vehicular security interest 110 and/or the party interested in acquiring the vehicular security interest and/or vehicular loan portfolio 112 may utilize the location and time of start/stop ignition events to generate dynamic landmark 502. Dynamic landmarks may be stored, inventoried, analyzed, and categorized according to one or more exemplary embodiments. Dynamic landmark 502 may be a geo-point with a tight radius. A geospatial positioning device 104 based event 402 that may profile vehicle 102 may include, but may not be limited to: an ignition event which may be real (i.e., hard wired) or virtual (i.e., movement of vehicle 104 and battery voltage of vehicle 104), a tow event (i.e., movement of vehicle 102 without ignition), an ignition disable event, or a very low resolution continuous track, according to one or more embodiments.

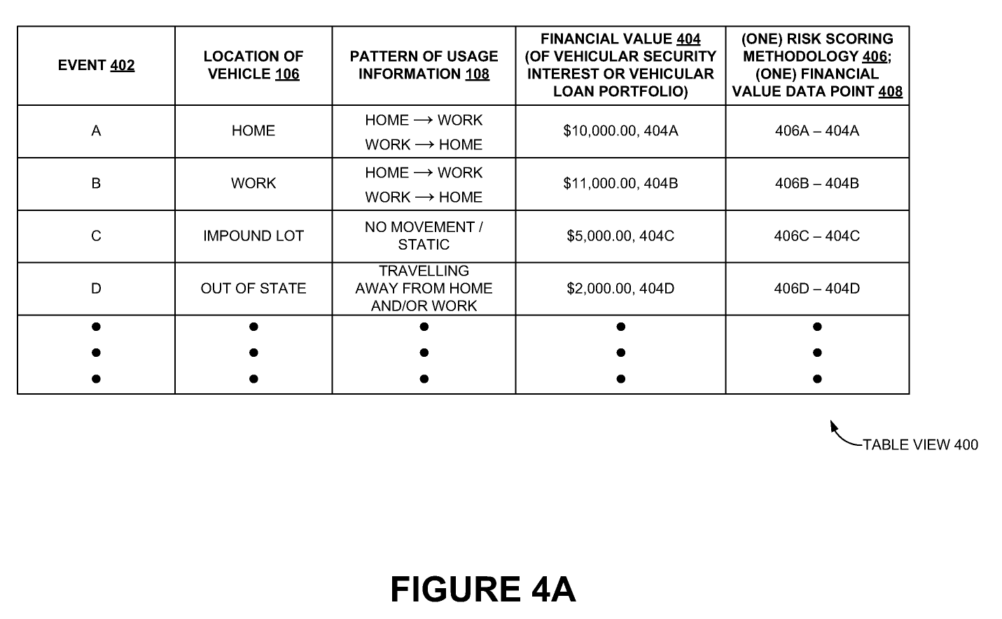

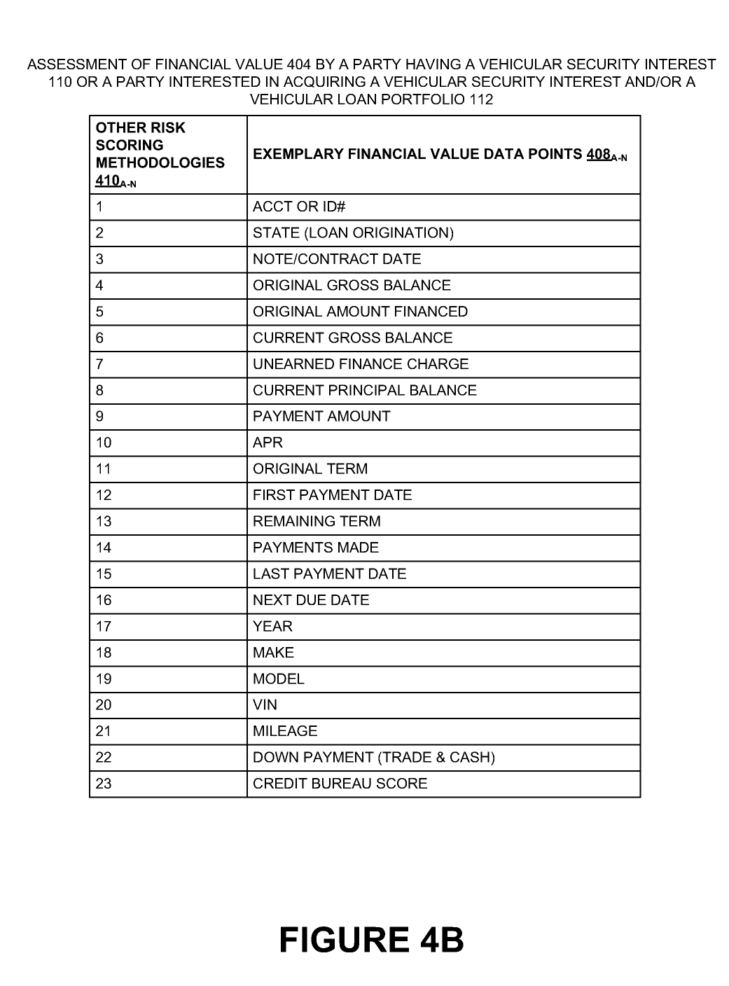

FIG. 4A is a table view 400 illustrating the effect of event 402 (associated with the location of the vehicle 406 and pattern of usage information 108) on the financial value 404 and financial risk (e.g., risk score 604) associated with the vehicular security interest 114, according to one or more embodiments. Event 402 may be one event or several events (e.g., A, B, C, D, etc.). For example, if the location of vehicle 106 is at home and the pattern of usage information 108 indicates a pattern of driving from home to work and back home from work, the financial value 404A of the vehicular security interest 114 may be $10,000.00 and may be associated with financial value 404A. The financial value 404A may correspond to at least one risk scoring methodology 406 based on at least one financial value data point 408. Thereby, financial value 404A may correspond with risk scoring methodology 406A associated with financial value data point 408A, according to one embodiment. On the other hand, if the location of vehicle 106 is out of state and the pattern of usage information 108 indicates a pattern of driving away from home and/or work, the financial value 404D of the vehicular security interest 114 may be $2,000.00, indicative of higher risk associated with risk scoring methodology 406D, according to one or more embodiments.

FIG. 4B illustrates other risk scoring methodologies 410 and exemplary financial value data points 408A-N that may be used to assess the financial value 404 of the vehicular security interest 114, according to one or more embodiments. Other financial value data points 408A-N that may contribute to the assessment of financial value 404 may include, but are not limited to: an account or identification number, the state of loan origination, the date of the note and/or contract, the original gross loan balance, the original amount financed, the current gross loan balance, the unearned finance charge, the current principal balance, the payment amount, the annual percentage rate of the loan, the original term of the loan, the first payment date, the remaining term of the loan, the number of payments made, the next due date, the year of vehicle 102, the make of vehicle 102, the model of vehicle 102, the vehicle identification number (VIN) of vehicle 102, the mileage on vehicle 102, the down payment made, and the credit bureau score of the borrower, according to one or more embodiments. There financial data points 408A-N, in addition to the location of the vehicle 106 and pattern of usage information 108, may contribute to the assessment of financial value 404 of the vehicular security interest 114 and/or the vehicular loan portfolio 602 by a party having a vehicular security interest 110 and/or a party interested in acquiring a vehicular security interest and/or a vehicular loan portfolio 112, according to one or more exemplary embodiments.

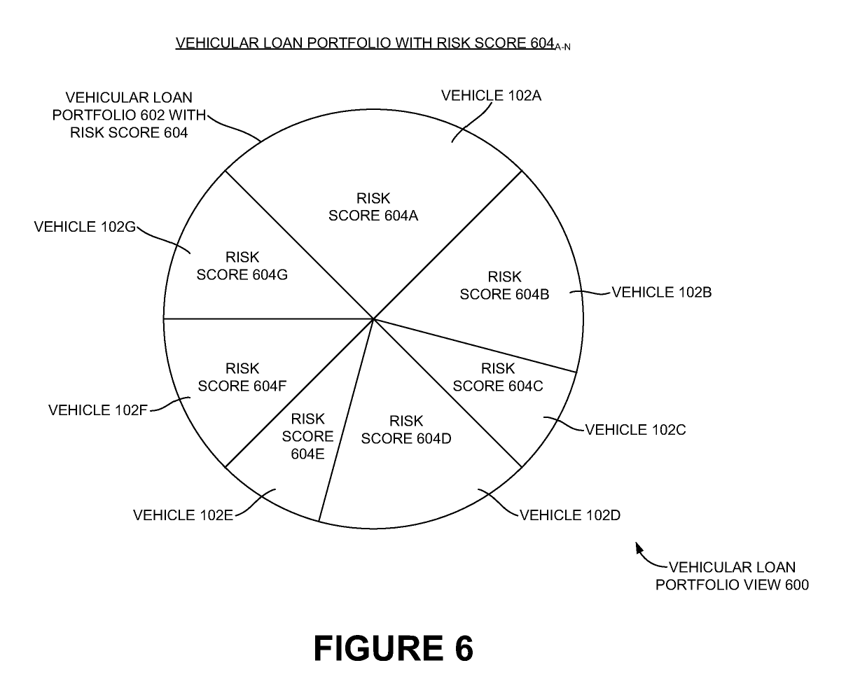

FIG. 6 is a vehicular loan portfolio view 600 illustrating a pie chart that details just one possible embodiment of the vehicular loan portfolio 602 with multiple vehicles and multiple risk scores, according to one or more embodiments. A vehicular loan portfolio 602 may comprise one or more risk scores 604 and one or more vehicles 102, according to one or more embodiments. The risk scoring methodology 406 may be dependent upon the financial value data point 408. Depending on the type of financial value data point 408, one or more risk scoring methodologies 406A-N may be implemented to determine the risk scores 604A-N. Different vehicles may have different risk scores. According to one illustrative example as depicted in FIG. 6, the vehicular loan portfolio 602 may comprise seven vehicles 102A-G, each with its own unique corresponding risk score 604A-G. The risk scores 604A-G may be calculated using one or more risk scoring methodologies 406A-N and associated financial value data points 408 (see FIGS. 4A and 4B). Accordingly, and according to one or more illustrative examples, the financial value 404A-G for all seven vehicles 102A-G may be determined based on risk scores 604A-G in addition to one master financial value 404 for the entire vehicular loan portfolio 602.

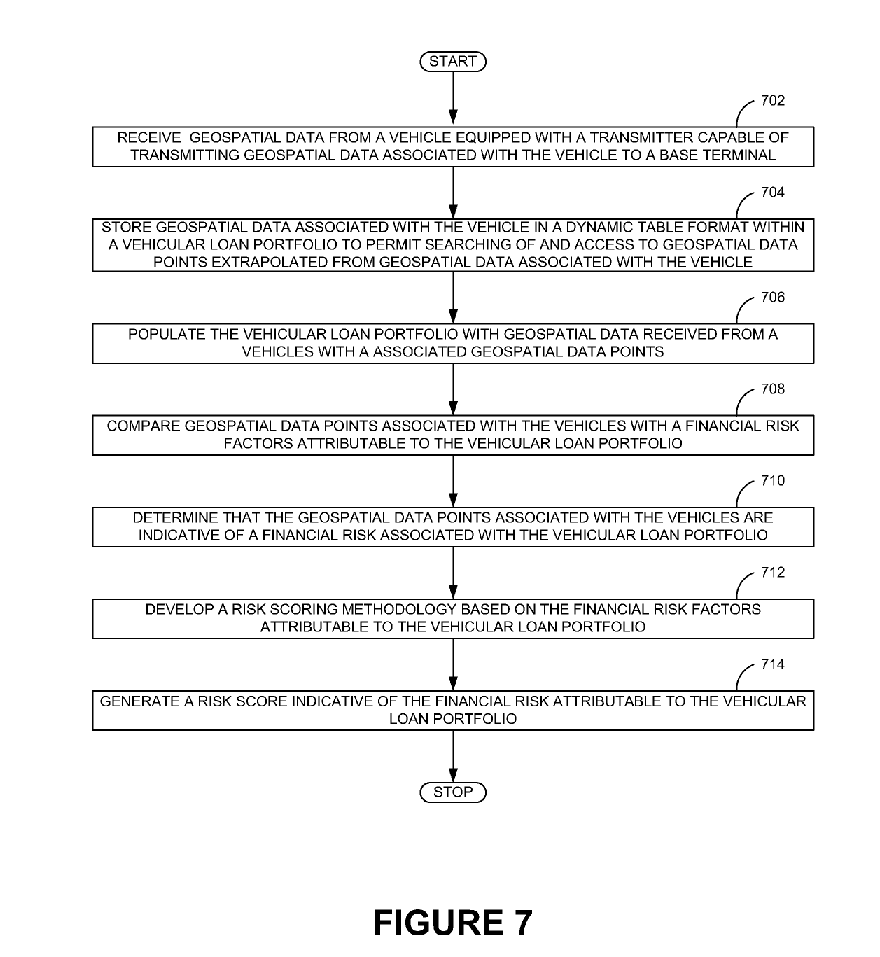

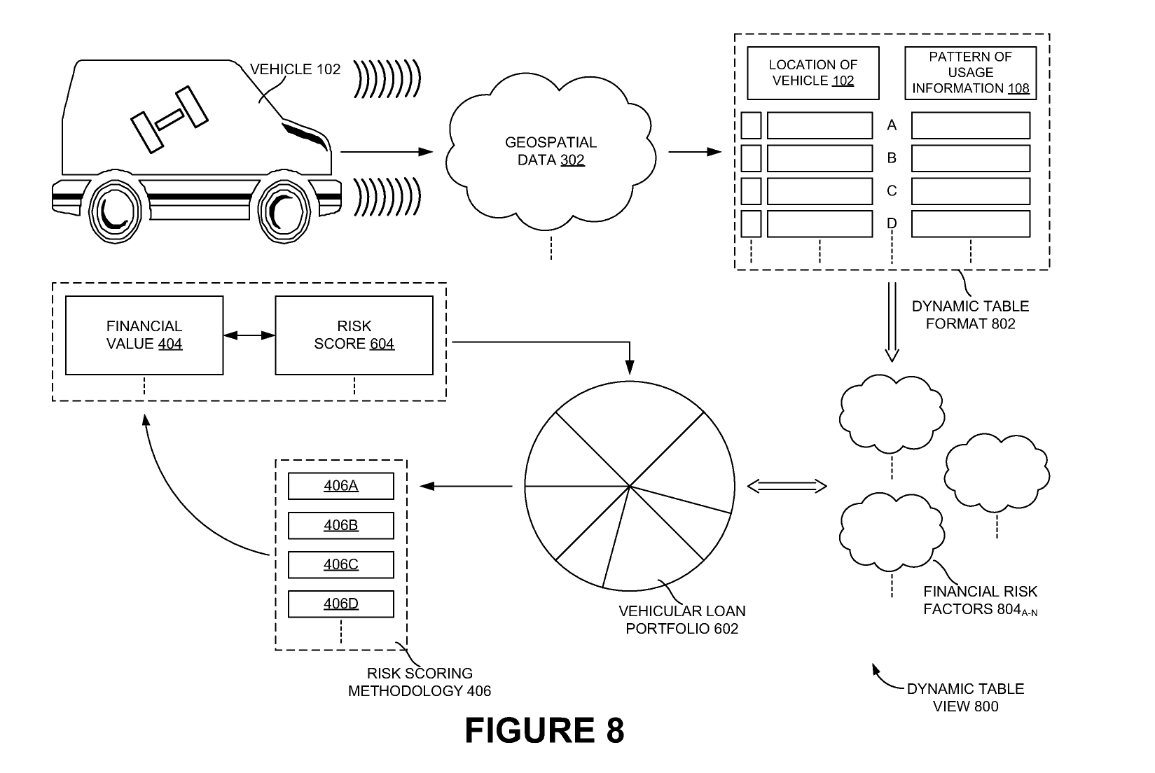

It will be further appreciated that, according to one or more exemplary embodiments and FIGS. 7 and 8, the method may involve receiving geospatial data 302 from the vehicle 102 equipped with geospatial positioning device 104 capable of transmitting geospatial data 302 associated with vehicle 102 to a base terminal. The geospatial data 302 associated with vehicle 102 may then be stored in a dynamic table format 802 associable with the vehicular loan portfolio 602 to permit the searching of and access to at least one geospatial data point (e.g., financial value data point 408) extrapolated from geospatial data 302 associated with vehicle 102. The method may further involve populating the vehicular loan portfolio 602 with geospatial data 302 received from a plurality of vehicles (see FIG. 6) with a plurality of associated geospatial data points (e.g., financial value data point 408). The geospatial data points associated with the plurality of vehicles may be compared with a plurality of financial risk factors attributable to the vehicular loan portfolio 602, according to one embodiment.

FIG. 7 is a flow chart illustrating the extrapolation of geospatial data 302 to a dynamic table format 802 to assess financial value 404 and/or financial risk (e.g., risk score 604) of the vehicular loan portfolio 602, according to one or more embodiments. FIG. 8 is a dynamic table view 800 that illustrates the determination of financial value 404 and financial risk (e.g., risk score 604) associated with the vehicular loan portfolio 602, according to one or more embodiments. According to one embodiment, geospatial data points associated with the plurality of vehicles may be indicative of a financial risk associated with the vehicular loan portfolio 602. The risk scoring methodology 406 may be based on the plurality of financial risk factors attributable to the vehicular loan portfolio 602 and may be used to generate risk score 604 indicative of the financial risk attributable to the vehicular loan portfolio 602, according to one or more embodiments.

In other embodiments, the determination that geospatial data points associated with the plurality of vehicles are indicative of a financial risk associated with the vehicular loan portfolio 602 may be used to determine the credit worthiness of the vehicular loan portfolio 602 in addition to a lender evaluation of the vehicular loan portfolio 602 and a lender search for the vehicular loan purchase. The lender evaluation of the vehicular loan portfolio 602 may comprise reporting data indicative of the financial risk associated with the vehicular loan portfolio 602 to the party having a vehicular security interest 110 and/or the party interested in acquiring the vehicular security interest and/or the vehicular loan portfolio 112. The party having a vehicular security interest 110 and/or the party interested in acquiring the vehicular security interest and/or the vehicular loan portfolio 112 may apply a risk scoring methodology 406 to the data indicative of the financial risk associated with the vehicular loan portfolio 602, according to one or more exemplary embodiments.

In addition, an Intelligent Caching Engine (ICE) may be implemented and may include a method of storing geospatial data 302 in a dynamic table format 802 (see FIG. 8) that may allow for rapid searching of and access to multiple data points on multiple vehicles, according to one or more embodiments. The multiple data points may be stored on a per dealership basis or across all available dealers who may be looking for a party having a vehicular security interest 110 and/or the party interested in acquiring the vehicular security interest and/or the vehicular loan portfolio 112, according to one or more embodiments. The ICE may execute the storing of the dynamic landmarks (e.g., 502A and 502B) and may act as the storage engine for event 402 and the dynamic landmark information (e.g., in the form of geospatial data 302). Under ICE, all events may be analyzed regardless of their type against geo-rules which may allow for landmark and/or geo-fence information to be determined on any event type and may be calculated historically by re-analyzing previously received and/or retrieved geospatial data 302, according to one or more embodiments.

It will be appreciated that the ICE may have the ability to count the dynamic landmark events and may also have the ability to rapidly compute the time spent by the borrower at dynamic landmark 502 (e.g., dynamic landmark 502A or 502B of FIG. 5), according to one or more exemplary embodiments. It will also be appreciated that, according to one or more embodiments, dynamic landmark 502 may be placed in a library. Events (e.g., A, B, C, D, etc. of FIG. 4A) may be stated up against the library and may provide valuable information to the party having a vehicular security interest 110 and/or the party interested in acquiring the vehicular security interest and/or the vehicular loan portfolio 112. Example library elements may include, but are not limited to: impound yards, dealer lots, zip codes, states, and economic zones, according to one or more exemplary embodiments. For example, vehicle 102 (or multiple vehicles) which may be located at a common dynamic landmark for a number of days may identify a possible impound yard which may then be added to the library, according to one embodiment.

In yet another embodiment, the event 402 may comprise a low power and power ON/OFF event that may be helpful to reduce tampering and/or problems with the vehicle 102. If a power ON/OFF event occurs too frequently, the borrower may become dissatisfied or may end up spending too much money on repairing vehicle 102 and may be late in paying the loan. In addition, and according to another embodiment, the frequency of the power ON/OFF event may also dictate whether the borrower is missing work. Combining the efficacies of the power ON/OFF event and the movement of the vehicle 102, may provide the party having a vehicular security interest 110 and/or the party interested in acquiring the vehicular security interest and/or the vehicular loan portfolio 112 with a superior method of assessing the financial value 404 and risk score 604 associated with the vehicular security interest 114 and/or the vehicular loan portfolio 602, according to one or more exemplary embodiments. According to one exemplary embodiment, a VIN detection technology may be implemented to decipher whether the vehicle 102 being monitored is the correct vehicle (i.e., the vehicle 102 belongs to the borrower). This VIN detection technology may also be applied, in one exemplary embodiment, to discover if the geospatial positioning device 104 has been transferred to another vehicle.

Other aspects of the invention will be apparent according to several embodiments related to a lender and the benefits that this invention may provide for a lender. According to one or more embodiments, the lender, who could be the party having a vehicular security interest 110 and/or the party interested in acquiring the vehicular security interest and/or the vehicular loan portfolio 112, may be provided access to and/or an option to consider, evaluate and purchase a bulk deal from one (or more) particular automobile dealers based on the criteria the lender and/or the dealer sets. For example, if the pattern of usage information 108 and the location of the vehicle 106 reveal that the vehicle 102 is close to home at night and only travels one, two, or three miles on any given night, this information can be saved as data important to a lender. The lender may access a report generation portal and may set particular criteria to measure risk of the vehicular security interest 114 and/or the vehicular loan portfolio 602. The data indicative of financial value 404, the risk score 604 etc. may be parsed and the lender may be given a ranking (of the vehicular security interest 114 and/or the vehicular loan portfolio 602) indicating the range of risk between the least risk to the greatest risk based on such criteria.

It may be that, according to one or more embodiments, the lender may not care about the miles driven by vehicle 102. However, this method, according to an illustrative example, may allow lenders to preset their own criteria (to measure risk) prior to analyzing an automobile dealer's vehicular loan portfolio (e.g., vehicular loan portfolio 602). Lenders may assess their own risk models (e.g., risk scoring methodology 406) and dealers may find a “fit” in a lender, thus increasing the chance that a dealer can attract a suitable lender. The lenders may be permitted to download the data geospatial retrieved from the vehicle 102 and may be allowed to parse the data as they desire, according to one or more embodiments. According to other exemplary embodiments, dealers may be allowed to indicate that they are searching for a lender or multiple lenders and the lender may be permitted to search across the dealer's entire database for risk profiles that meet the criteria set by lender(s).

According to other illustrative examples, a method of geospatial data based financial risk measurement of a vehicular security interest 114 and/or a vehicular loan portfolio 602 may comprise retrieving geospatial data 302 indicative of at least one of a location of a vehicle 106 and a pattern of usage information 108 associable with the vehicle 102 from a geospatial positioning device 104 in vehicle 102. Next, a risk scoring methodology 406 may be developed that contributes to the measurement of a financial risk of the vehicular security interest 114 and/or the vehicular loan portfolio 602 based on at least one of the location of the vehicle 106 and/or the pattern of usage information 108 associable with vehicle 102 and retrieved from the geospatial positioning device 104 in vehicle 102. A risk score 604 associated with the vehicular security interest 114 and/or the vehicular loan portfolio 602 based on the risk scoring methodology 406 may be generated to indicate the financial risk, according to one or more embodiments.

It will be appreciated that, according to one or more embodiments, the risk scoring methodologies associated with the vehicular security interest 114 and/or the vehicular loan portfolio 602 may be applicable to and may be applied to calculate the financial risk applicable to the vehicular security interest 114 and/or an entire vehicular loan portfolio 602. This embodiment of the method may include utilizing geospatial data to generate an appropriate financial risk score applicable to the vehicular security interest 114 and/or the vehicular loan portfolio 602. For example, geospatial data 302 indicative of the location of a vehicle 106 and the pattern of usage information 108 associable with vehicle 102 from a geospatial positioning device 104 in vehicle 102 may be utilized to measure whether the driver is a safe driver or not. Thus, an appropriate risk score 604 may become applicable to each vehicular security interest 114 and/or collectively, the vehicular loan portfolio 602 based on each individual's driver's driving behavior gleaned from the location of the vehicle 106 and the pattern of usage information 108.

According to one or more exemplary embodiments, a risk scoring methodology 406 may be developed that contributes to and/or measures the risk score 604 of the vehicular security interest 114 and/or the vehicular loan portfolio 602 based the location of the vehicle 106 and the pattern of usage information 108 associable with vehicle 102 and retrieved from the geospatial positioning device 104 in vehicle 102. A risk score 604 associated with the vehicular security interest 114 and/or the vehicular loan portfolio 602 based on the risk scoring methodology 406 may be generated based on the driver's usage behavior, location, and/or his/her pattern of usage. For example, the method, according to one or more illustrative embodiments, may capture and report on a significant number of parameters including, but not limited to: trip start date and time, duration, distance, maximum speed, times in different speed bands, number of hard braking events, number of extreme braking events (e.g., could be classified as an accident), number of hard acceleration events (e.g., could signify unsafe driving and/or street racing), time spent idling, and snapshots of speed at defined intervals, etc. On the other hand, this type of usage based financial risk measurement and/or assessment would also take into consideration factors such as gentle braking, driving slower than the average driver's speed, following speed limits, minimizing driving during rush hours, not driving between 12:00 A.M. and 4:00 A.M. etc. in measuring and/or assessing the financial risk associable and/or applicable to the vehicular security interest 114 and/or an entire vehicular loan portfolio 602, according to one or more exemplary embodiments.

Although the present embodiments have been described with reference to specific example embodiments, it will be evident that various modifications and changes may be made to these embodiments without departing from the broader spirit and scope of the various embodiments. For example, the various devices (e.g., the geospatial positioning device 104), modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry). For example, data transmission technologies, geospatial positioning devices, and devices other than ones employing GPS technology (e.g., RFID, RTLS, OEM telematics, location detection based on cell phone towers, electromagnetic waves, optical emissions, infrared, radar, sonar, radio, Bluetooth™ etc.) may be used to transmit geospatial data 302 for the purposes of the invention described herein, according to one or more exemplary embodiments.

Particularly, several modules as illustrated in FIG. 2 may be employed to execute the present embodiments. The vehicle module 202, the vehicular security interest module 204, the vehicular loan portfolio module 206, the location module 208, the pattern of usage module 210, the base terminal module 212, the geospatial positioning device module 214, the risk scoring methodology module 216, the risk score module 218 and all other modules of FIGS. 1-8 may be enabled using software and/or using transistors, logic gates, and electrical circuits (e.g., application specific integrated ASIC circuitry) such as a security circuit, a recognition circuit, a dynamic landmark circuit, an ignition event circuit, a store circuit, a transform circuit, an ICE circuit, and other circuits.

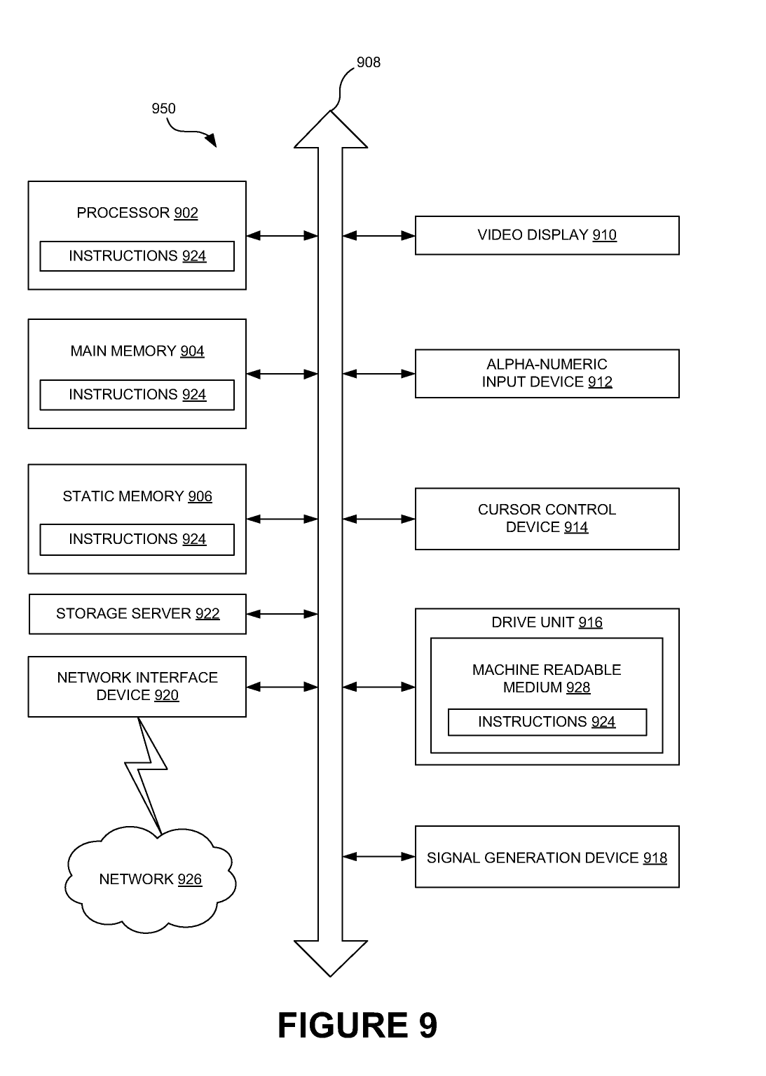

FIG. 9 may indicate a personal computer and/or the data processing system in which one or more operations disclosed herein may be performed. The processor 902 may be a microprocessor, a state machine, an application specific integrated circuit, a field programmable gate array, etc. (e.g., Intel® Pentium® processor, 620 MHz ARM1176®, etc.). The main memory 904 may be a dynamic random access memory, a non-transitory memory, and/or a primary memory of a computer system. The static memory 906 may be a hard drive, a flash drive, and/or other memory information associated with the data processing system. The bus 908 may be an interconnection between various circuits and/or structures of the data processing system. The video display 910 may provide graphical representation of information on the data processing system. The alpha-numeric input device 912 may be a keypad, a keyboard, a virtual keypad of a touchscreen and/or any other input device of text (e.g., a special device to aid the physically handicapped). The cursor control device 914 may be a pointing device such as a mouse. The drive unit 916 may be the hard drive, a storage system, and/or other longer term storage subsystem. The signal generation device 918 may be a bios and/or a functional operating system of the data processing system. The network interface device 920 may be a device that performs interface functions such as code conversion, protocol conversion and/or buffering required for communication to and from the network 926. The machine readable medium 928 may provide instructions on which any of the methods disclosed herein may be performed. The instructions 924 may provide source code and/or data code to the processor 902 to enable any one or more operations disclosed herein.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method comprising:
permitting at least one of a party having a vehicular security interest and a party interested in acquiring at least one of the vehicular security interest and a vehicular loan portfolio, access to at least one of a location of a vehicle and a pattern of usage information associable with the vehicle through a geospatial positioning device installed within the vehicle;
utilizing a data link from a base terminal communicatively coupled to the geospatial positioning device such that geospatial data associated with the vehicle is transmitted from the geospatial positioning device to the base terminal via the data link;
determining at least one of the location of the vehicle and the pattern of usage information associable with the vehicle based on geospatial data received from the geospatial positioning device via the data link;
comparing at least one of the location of the vehicle and the pattern of usage information associable with the vehicle and received from the geospatial positioning device to an event;
developing a risk scoring methodology that contributes to the assessment of a financial value of at least one of the vehicular security interest and the vehicular loan portfolio when at least one of the location of the vehicle and the pattern of usage information associable with the vehicle matches the event; and
generating a risk score associated with at least one of the vehicular security interest and the vehicular loan portfolio based on the risk scoring methodology.

2. The method of claim 1 wherein at least one of the location of the vehicle and the pattern of usage information associable with the vehicle is utilized to create the risk score indicative of the financial value of the vehicular security interest.

3. The method of claim 1 wherein the vehicular security interest is at least one of a singular security interest associated with one vehicle and a vehicular loan portfolio security interest associated with multiple vehicles.

4. The method of claim 1 wherein at least one of the party having the vehicular security interest and the party interested in acquiring the vehicular security interest is an organization.

5. The method of claim 4 wherein at least one of the party having the vehicular security interest and the party interested in acquiring the vehicular security interest is an agent of the organization.

6. The method of claim 1 wherein at least one of the location of the vehicle and the pattern of usage information associable with the vehicular security interest is based on a situs of at least one of a purchaser, a lessee, and a renter of the vehicle.

7. The method of claim 1 wherein at least one of the party having the vehicular security interest and the party interested in acquiring at least one of the vehicular security interest and the vehicular loan portfolio is at least one of a lender, a financial institution, an automobile dealership, a specialty finance company, an automobile dealership, a dealership finance company, a bank, a credit union, and a private financier.

8. The method of claim 1 wherein at least one of the location of the vehicle and the pattern of usage information associable with the vehicle that is incorporated in the vehicular loan portfolio and currently having the vehicular security interest is based on a dynamic landmark associated with the vehicle.

9. The method of claim 1 wherein the geo spatial data received from the geospatial positioning device is associated with a dynamic landmark.

10. The method of claim 9 wherein geospatial data received from the geospatial positioning device is utilized to compute the time the vehicle that is incorporated in the vehicular loan portfolio spends at the dynamic landmark.

11. The method of claim 10 further comprising generating the dynamic landmark:
using an ignition event associated with the vehicle incorporated in the vehicular loan portfolio;
using a known information provided by an owner of the vehicular security interest; and
determining the dynamic landmark using at least one of a historical location and a pattern of use behavior.

12. The method of claim 11 further comprising using the dynamic landmark to create a pattern of usage profile associated with the vehicle incorporated in the vehicular loan portfolio.

13. The method of claim 1:
wherein the event is determined by at least one of the party having the vehicular security interest and the party interested in acquiring at least one of the vehicular security interest and the vehicular loan portfolio;
wherein the event is associated with at least one of the location of the vehicle and the pattern of usage information associable with the vehicle; and
wherein the event comprises at least one of the vehicle not having moved from its current location for a period of time, the vehicle not having traveled a predetermined distance for a period of time, an ignition of the vehicle having not been at least one of started and stopped a predetermined number of times, the vehicle having been at a predetermined location, and the vehicle not having been at a predetermined location.

14. The method of claim 13:
wherein the predetermined distance is determined by at least one of the party having a vehicular security interest and the party interested in acquiring at least one of the vehicular security interest and the vehicular loan portfolio; and
wherein the predetermined location is dynamically generated using at least one of geospatial data and the pattern of usage information by at least one of the party having a vehicular security interest and the party interested in acquiring at least one of the vehicular security interest and the vehicular loan portfolio.

15. A method comprising:
receiving geospatial data from a vehicle equipped with a geospatial positioning device capable of transmitting geospatial data associated with the vehicle to a base terminal;
storing geospatial data associated with the vehicle in a dynamic table format associable with a vehicular loan portfolio to permit at least one of searching of and access to at least one geospatial data point extrapolated from geospatial data associated with the vehicle;
populating the vehicular loan portfolio with geospatial data received from a plurality of vehicles with a plurality of associated geospatial data points;
comparing geospatial data points associated with the plurality of vehicles with a plurality of financial risk factors attributable to the vehicular loan portfolio;
determining that the geospatial data points associated with the plurality of vehicles are indicative of a financial risk associated with the vehicular loan portfolio;
developing a risk scoring methodology based on the plurality of financial risk factors attributable to the vehicular loan portfolio; and
generating a risk score indicative of the financial risk attributable to the vehicular loan portfolio.

16. The method of claim 15 wherein the determination that the geospatial data points associated with the plurality of vehicles are indicative of a financial risk associated with the vehicular loan portfolio is used to determine a credit worthiness of the vehicular loan portfolio.

17. The method of claim 16 wherein the determination that the geospatial data points associated with the plurality of vehicles are indicative of a financial risk associated with the loan portfolio is used for at least one of a lender evaluation of the vehicular loan portfolio and a lender search for the vehicular loan purchase.

18. The method of claim 17 wherein the lender evaluation of the vehicular loan portfolio comprises:
reporting data indicative of the financial risk associated with the vehicular loan portfolio to at least one of a party having a vehicular security interest and a party interested in acquiring at least one of the vehicular security interest and a vehicular loan portfolio; and
permitting at least one of the party having a vehicular security interest and the party interested in acquiring at least one of the vehicular security interest and the vehicular loan portfolio to apply a risk scoring methodology to the data indicative of the financial risk associated with the vehicular loan portfolio.

19. A method of geospatial data based financial risk measurement of at least one of a vehicular security interest and a vehicular loan portfolio comprising:
retrieving geospatial data indicative of at least one of a location of a vehicle and a pattern of usage information associable with the vehicle from a geospatial positioning device in the vehicle;
developing a risk scoring methodology that contributes to the measurement of a financial risk of at least one of the vehicular security interest and the vehicular loan portfolio based on at least one of the location of the vehicle and the pattern of usage information associable with the vehicle retrieved from the geospatial positioning device in the vehicle; and
generating a risk score associated with at least one of the vehicular security interest and the vehicular loan portfolio based on the risk scoring methodology.
